(19) United States
(12) Patent Application Publication
(10) Pub. No.: US 2016/0092297 A1
(43) Pub. Date: Mar. 31, 2016

(54) API Gateway System and Method

(71) Applicant: Digital River, Inc., Minnetonka, MN (US)

(72) Inventors: Armando Mazon, New Hope, MN (US); Jonathan Kenneth Losch, Minnetonka, MN (US)

(73) Assignee: Digital River, Inc., Minnetonka, MN (US)

(21) Appl. No.: 14/869,613

(22) Filed: Sep. 29, 2015

Related U.S. Application Data
(60) Provisional application No. 62/057,118, filed on Sep. 29, 2014.

(51) Int. Cl. G06F 11/07; G06F 9/54

(52) U.S. Cl. CPC G06F 11/0793; G06F 11/0751; G06F 11/079; G06F 9/541

(57) ABSTRACT

An API gateway provides a failure policy for services that fail when presented with a request. An API definition includes a policy for controlling subsequent calls to a server once failures are detected. The policy provides a threshold number of failures before requests are failed-fast. After a timeout period, requests are again presented to the service in an attempt to reset the system. The first request is allowed to pass and subsequent calls are either allowed to pass, if the requests succeed, or fail fast if the requests fail. When the requests succeed, the system follows a procedure to ramp up the use of the service in order to allow the system time to recover, by looping through stages configured by the service and set out in the API definition.

This application claims the benefit of U.S. Provisional Patent Application No. 62/057,118, filed on 29 Sep. 2014 and titled “Dispatch Gateway for E-Commerce Platform System and Method,” which is incorporated herein by reference in its entirety.

### FIELD OF THE INVENTION

The present invention relates to ecommerce, and more particularly, relates to a system and method for providing API-related services in a networked environment.

### BACKGROUND OF THE INVENTION

Application Programming Interfaces (APIs) are becoming increasingly popular for delivering services over the internet. APIs link businesses and developers with information and content around which they can grow their applications and their businesses. While it is becoming easier to expose an API to a potential audience, it is becoming more difficult to manage and monitor the operational aspects of the API, especially as the number of services accessed grows and the service systems become more complex. Services can employ anywhere from a few to hundreds of servers, and it is crucial for API performance that the API be able to locate a healthy server to obtain a response.

API gateways employ various load balancing schemes to determine where to send a request. Some, such as discovery services, provides some indication of which of a service′ servers are capable of receiving and processing a request. However, discovery services requires that the service register their servers with the gateway and maintain their registrations as their configuration changes. A method for discerning the health of a potential service and bringing failed systems back online without requiring maintenance on the part of the service is desired. The invention described herein offers a solution to that problem and offers other benefits over the prior art.

### SUMMARY OF THE INVENTION

A self-contained API gateway is disclosed. In one embodiment, the gateway comprises all of the components required to provide its core features without relying out outside systems. All of the code and information that the system needs to process requests are available within the running system. It is not dependent on external features, such as databases, or other services to provide its core features, although integration with external systems is possible. The gateway may be comprised of a gateway developer portal, a code base stored in memory which when executed by the processer performs the features of the system by efficiently receiving and routing requests and responses from clients to services and back. A set of dynamic scripts provide all the details required for handling requests and responses, and an embedded server allows the system to be runnable with all features without first installing a web server.

In accordance with another aspect of the disclosure, efficient and accurate routing is provided using a wide variety of load balancing techniques, including a static list of available servers, a discovery service, a domain name, HTTP method-type routing, region-based routing, and performance-based routing. A modified circuit-breaking feature provides a failure policy that benefits an ailing server as it recovers from failure. Those of ordinary skill in the art will recognize that this feature offers significant improvements over the prior art and offers other benefits which will become apparent throughout the disclosure.

### DESCRIPTION OF THE DRAWINGS

FIG. 1 is illustrates an exemplary API Gateway as described in this specification

FIG. 2 illustrates the flow of a request and response from a client to a service and back

FIG. 3 illustrates the flow of a request/response through pre-routing, routing and post-routing filters

FIG. 4 illustrates the circuit breaker scheme used if a service has a circuit breaker policy in the API definition file

### DETAILED DESCRIPTION

The presently disclosed embodiments will now be described more fully hereinafter with reference to the accompanying drawings, in which some, but not all, embodiments of the inventive concept are shown. The invention may be embodied in many different forms and should not be construed as limited to the embodiments set forth herein; rather, these embodiments are provided so that this disclosure will satisfy applicable legal requirements. Like numbers refer to like elements throughout.

It will be appreciated by those of ordinary skill in the art that the described embodiments may be realized as a method, system, computer program product, or a combination of the foregoing. Accordingly, the disclosed embodiments may take the form of an entirely hardware embodiment, an entirely software embodiment (including resident software, microcode, etc.), or an embodiment combining software and hardware aspects that may generally be referred to herein as a “system.” The embodiments may also take the form of a computer program product on a non-transitory computer-readable medium having computer-usable program code embodied in the medium.

Any suitable non-transitory computer-usable or computer-readable storage medium may be utilized. The computer-usable or computer-readable storage medium may be, for example, but is not limited to, an electronic, magnetic, optical, electromagnetic, infrared, or semi-conductor system, apparatus, or device, but does not include a signal per se. Other examples include a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. In the context of this document, a non-transitory computer-usable or computer-readable storage medium may be any non-transitory medium that can contain or store a program for use by or in connection with an instruction execution system, apparatus, or device.

Computer program code for carrying out operations of the present invention may be written in any type of programming language capable of implementing its features. The program code may be written in sets of instructions, such as program modules that include routines, programs, objects, components, data structures, etc. that perform particular tasks or implement the features described. The program code may execute on one or more processors that may be remote from each other, or as a stand-alone software package. One of skill in the art will recognize that computer program code contains instructions that may be provided to a processor of a general purpose computer, special purpose computer, or other programmable data processing apparatus to produce a machine, such that the instructions, which execute via the processor of the computer or other programmable data processing apparatus, create means for implementing the features of the invention described below. Computer-executable instructions may be stored in a non-transitory computer-readable memory, as described above, that can direct a computer or other programmable data processing apparatus to function in a particular manner, such that the instructions stored in the computer-readable memory produce an article of manufacture including instruction means which implement the features described herein. The computer program instructions may be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions/acts specified herein described in text or as specified in a flowchart and/or block diagram block or blocks. Alternatively, computer program implemented steps or acts may be combined with operator or human implemented steps or acts in order to carry out an embodiment of the invention.

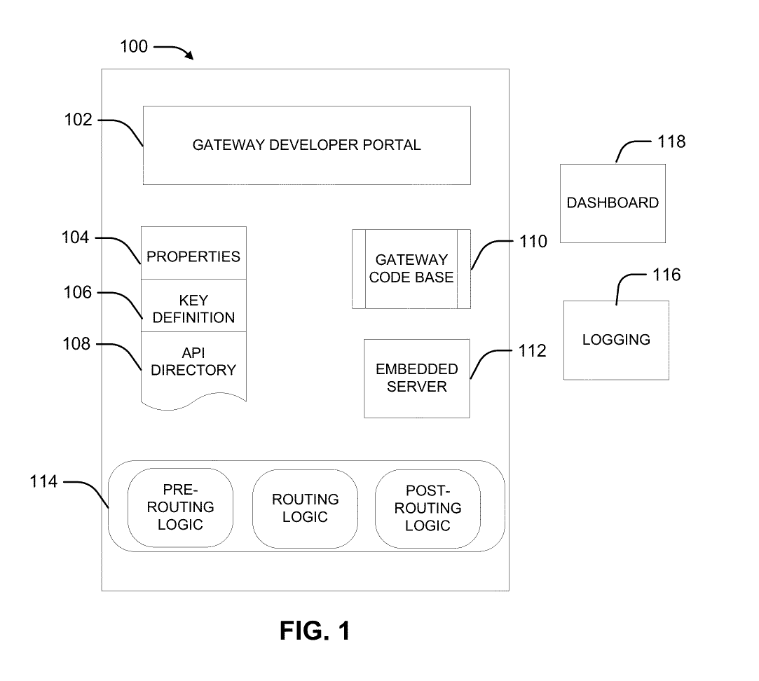

The present disclosure describes various embodiments of a system and methods for providing API-related services over a network. In one embodiment, instances of an API gateway is an entirely self-contained unit. All of the code and information that the system needs to process requests are available within the running system. It is not dependent on external features, such as databases, or other services to provide its core features, although integration with external systems is possible. Referring to FIG. 1, an API gateway 100 may include a gateway developer portal 102. A gateway developer portal may provide services to gateway and development clients and services. For example, a gateway developer portal 102 may provide forms with which to request security information, such as a key and secret, and to register services. Further, a gateway developer portal 102 may include an editor allowing developers to enter code, policies and configuration details to be added to dynamic scripts 104, 106, 108 which are then validated and added to the production script. The new script may then be pushed out to any additional instances of the gateway. The files are used as read only repositories; all the other data needed by Dispatch is kept in data structures in memory.

The dynamic scripts 104, 106 and 108 provide the system with the data it needs to process requests. A properties file 104 provides general configuration settings, such as the location of data. A key definition file 106 contains security and rate limit information including information on the user(s), public or confidential status (confidential keys may require a secret, which is optional with a public key), authorized services, custom attributes which may be sent to the service as headers any time a request is made with the key, rate limits and accessible environments. An API definition file 108 includes all the information related to the service and the API that the system needs. Included are the service name and purpose, expected traffic, capacity constraints, means of access, architecture details, whether card holder data is included, whether personal identifiable information is included, and security information. In addition, technical details are included such as service identification details, the origin URL, and environment. Data that would also be included in the API definition includes details on capacity, failure/failover protocol and other policies of the services system. Services may be internal or external. One of ordinary skill in the art will recognize that these files may contain other information, including any information that are API/service specific that would be required or helpful in providing API services to the origin service.

Referring again to FIG. 1, the system further includes a gateway code base 110 component required to run the API Gateway. The code may be written in any suitable language Instead of relying on a web server as an additional entity to be configured before the API Gateway can serve requests, the API Gateway system contains an embedded server 112 allowing the system to be fully contained and runnable anywhere, greatly simplifying setup and maintenance tasks.

The API Gateway further comprises pre-routing, routing and post-routing logic 114, which will be discussed further, below. These modules provide the logic required to access the services registered with the gateway. Additional peripheral tools may be used by the API Gateway, including logging 116, which tracks all requests and responses and their errors, performance metrics, etc. for monitoring and analysis via an API Gateway dashboard 118.

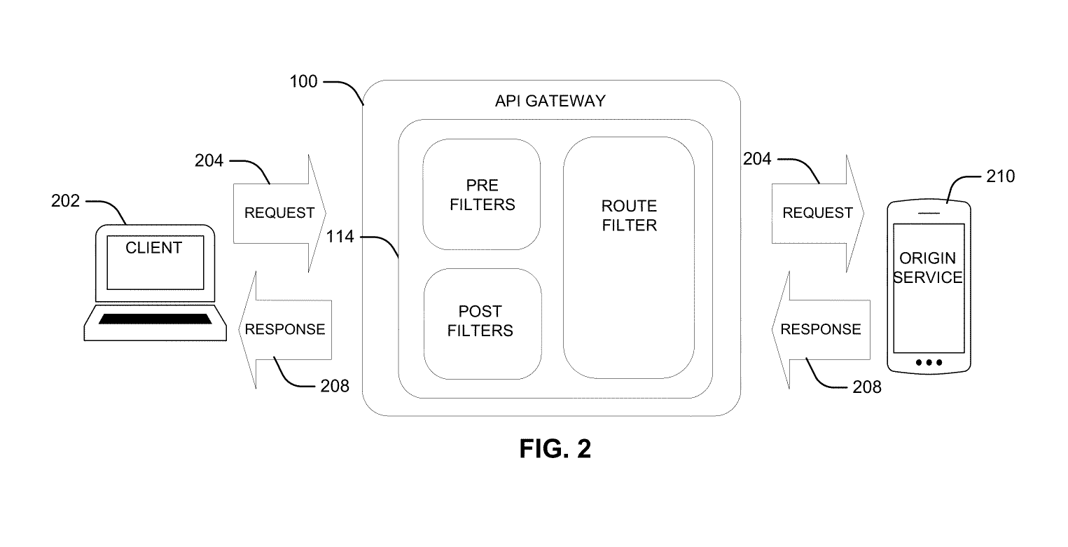

FIG. 2 illustrates the API Gateway and the flow of information from the client to the origin service 210 and back to the client. Requests 204 are processed through pre-filters and route filters on the way to the origin service 210, and the responses are processed through post filters on the way back. A client 202 may access a registered service 210 by sending a request 204 to the gateway 100. A request 204 may contain an authorization key identifying the client 202, and a location indicator for the service 210 sought. A location indicator could be any kind of name or address identifying the targeted service 210. For example, a client 202 may send a URL identifying the service 210. The request 204 passes through a set of pre-filters 114 (e.g. authorization and rate limiting), determined by the content of the request 204. Having passed through the pre-filters 114, requests are exposed to routing filters 114 that determine the endpoint of the request, which are discussed in detail below. The request 204 is passed to the origin service 210, which provides a response 208. The response 208 passes through a group of post-filters 114 on its way back to the client 202. All requests, response status and errors are logged 116 for dashboard 118 monitoring and analysis.

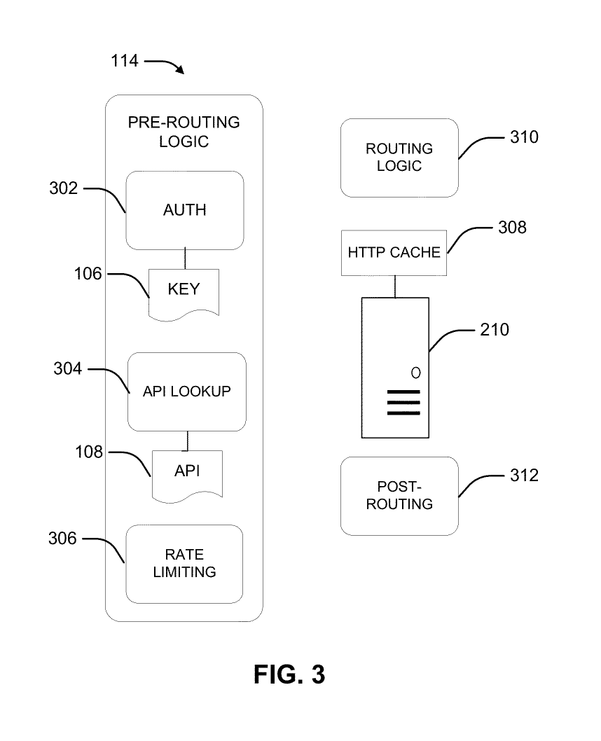

FIG. 3 illustrates exemplary routing logic for an API Gateway system and method. Referring back to FIG. 2, a client 202 makes a request 204 to the gateway 100, the request including a key, a secret, and/or a token, and an identification of the service 210 being called. The API gateway 100 receives the request and the gateway performs pre-routing 302, which may include authenticating 304 the request by looking up the key 106 and API definition 108, to ensure that the requestor is allowed access to the system and service, and what kind of access is allowed. The system determines whether the caller can call the service it's attempting to call. Rate limiting 306, if set for the key and service in their respective files, is applied.

In at least one embodiment, both the key (client) 202 and the origin service 210 have rate limits. Rate limits for the client 202 and origin service 210 may be configurable values in the key 106 and API definition files 108, respectively. In the rate limiting filter 306, the gateway system checks the key limit to ensure that the client has not exceeded their limit set for a particular period of time. The service may specify its own rate limit in its API definition file 108. If the request passes these checks and no errors are present, the system will add metadata, such as a request identifier, to the request header, and send the request to the service cache 308. If the cache can respond to the request, the response is provided from the cache 308. If not, routing logic 310 is applied. As will be described below, different embodiments may use one or more various routing, or load balancing, schemes to determine which particular service server to call. The request is sent to the origin service, and a response is returned.

The origin service 210 generates a response and returns it to the gateway. The gateway post-routing filter 312 manipulates the header to provide valuable information such as the request ID, and caches the result if a cache indicator has been received. The post-routing filters 312 may also block certain headers or strip out information that the client doesn't require. For example, some services may respond with cache indicators in their headers. The gateway 100 will use that information to update its cache, but will strip the information from the header when returning the response to the client.

Error handling and logging 116 are performed continually throughout the transaction. Messages (requests and responses), performance measures, errors, and more are continually sent to an event aggregator throughout the process. Once the response to the client is fully generated and sent, a record is written to the logging system for the entire transaction. This data is fed to the gateway dashboard 118 for monitoring and analysis.

The API gateway 100 may use one or more methods of load balancing in its routing logic 310 to determine where to send the request 204 to the target origin service 210. The methods described here are provided by way of example and not limitation. In some embodiments, the system may use a static list of available servers, a discovery service, a domain name, HTTP method-type routing, region-based routing, performance-based routing, and circuit breaking, alone or in some combination.

A static list of servers available for routing a request 204 to an origin service 210 may be provided. The static list has the advantage of being quickly and easily read, but must be updated as server status changes. The gateway may use a discovery service to register all available servers. A discovery service queries the registered services periodically to determine which servers are available, and updates the status. A static list of available servers may then be pulled periodically to replace the previous static list.

Routing 310 may also be performed by directing the message to a domain name. Additionally, messages might be directed to a particular server or set of servers depending on their HTTP method-type. For example, all GET methods might go to one server, but POST messages might go to another. Region-based (choosing the closest servers), performance-based (choosing the servers with the best historical response rates), or service-based routing may be used.

In addition to load balancing features, routing 310 filters can also include applying a failure policy, a modified “circuit-breaking” algorithm, to its service servers. In an API gateway 100, the failure policy may be applied via a configuration setting in the API definition file 108. If the system discovers that the origin service 210 is having problems handling a request, it prevents the client 202 from making calls to the origin service 210. Instead of repeatedly calling the service 210, it does a ‘fail-fast’ on subsequent calls, so the client 202 may decide to wait to make the call, or forgo it altogether. This scheme protects the origin service, allowing it to recover and restart, and aids the client by not making him wait for a response that will eventually fail.

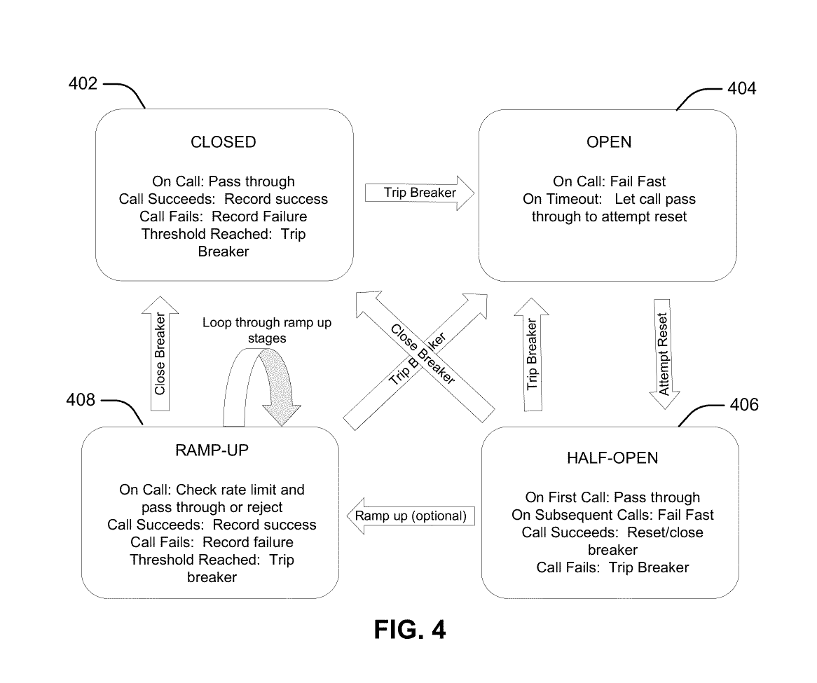

FIG. 4 illustrates the failure scheme used if a service has a failure policy in the API definition file 108, and one example of a modified circuit breaker policy. When the breaker is closed 402, the system is healthy and the calls will pass, responses 208 will be received and recorded, as will any request 204 failures. When a pre-set threshold is reached (for example, 5 fails in 10 minutes), the breaker is tripped and opened 404. Calls coming in when the circuit is open will fail fast (requests will fail immediately, without being sent to the service) until the breaker has been open for a configurable-threshold period; after that time the system passes one call to attempt reset and determine if the service is available again. The breaker may be converted to half-open 406, where the first call is passed. If the passed call is successful, the system is reset and the breaker is closed, and the system moves to a ramp up 408 state. Continued failed calls trip the breaker to the open position 404.

The ramp up state 408 provides the system with a process that allows the origin service some time to recover, and for the API gateway to reestablish processing with the affected server. If the breaker is half open 406, and the API definition file 108 specified stages that the service 210 must go through once the system is in a normal state, it does this rather than going to directly to closed. Ramp up 408 limits the number of calls that can be made to the service for a certain period of time, for example, 10 calls per minute for 5 minutes. Anything above that is rejected. The process loops through the stages, recording the successes and failures in order to determine whether the origin service 210 is healthy again and can receive calls successfully. If yes, the circuit may be closed 402 and receive calls. An example of the circuit breaker definition, policy and ramp up stages configured in the API definition file are provided in Table 1.

TABLE 1
Ramp Up Configuration

```
“circuitBreakerDefinition”: {
  “metricType”: “ROLLING”,
  “policy”: {
    “id”: “PercentageBasedPolicy”,
    “threshold”: 25,
    “enforcementThreshold”: 5,
    “resetTimeout”: {
    “time”: 5,
    “timeUnit”: “SECONDS”
    },
    “timePeriod”: {
    “time”: 30,
    “timeUnit”: “SECONDS”
    }
  },
  “fallbackResponse”: {
    “statusCode”: 503,
    “responseBody”: “Service unavailable”
  },
  “rampUpStages”: [
    {
    “rateLimit”: {
      “maxCalls”: 5,
      “timeUnit”: “SECONDS”
    },
    “duration”: {
      “time”: 10,
      “timeUnit”: “SECONDS”
    }
    },
    {
    “rateLimit”: {
      “maxCalls”: 10,
      “timeUnit”: “SECONDS”
    },
    “duration”: {
      “time”: 10,
      “timeUnit”: “SECONDS”
    }
    }
  ]
  }
```

The example failure policy specifies ramp up policy stages that provide for a rate limit of 5 calls per second for 10 seconds, and then 10 calls per second until the breaker is closed. One of ordinary skill in the art will recognize that many configurations of a ramp up policy are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. For example, the present techniques can be implemented in any kind of system that includes a hard disk drive. The embodiment was chosen and described in order to best explain the principles of the invention and the practical application and to enable others of ordinary skill in the art to understand the invention for various embodiments with various modifications as are suited to the particular use contemplated.

What is claimed:

1. (canceled)

2. A method for processing application programming interface (API) requests at an API gateway, comprising:
receiving an API request at a first computing device, the request comprising a key identifying the source of the request and an identification of the target of the request;
authenticating the request by matching the key to a key in a key identification file, and
identifying rate limits applied to the key and determining that the rate limits have not been exceeded;
determining limits placed on the target of the request by finding the service name and rate limits in an API definition file and ensuring the rate limit has not been exceeded;
determining, from the API definition file, the service policy for failure handling, where the policy describes a threshold for detecting failed services and a protocol for failing request calls and reestablishing service at the server; and
applying the failure handling policy to subsequent requests made to the service.

3. The method for processing application programming interface (API) requests at an API gateway of claim 1 wherein the API definition file includes threshold setting related to the number of failures in a first amount of time.

4. The method for processing application programming interface (API) requests at an API gateway of claim 2 wherein requests will be passed to a server when the number of failures is below a threshold setting related to the number of failures in a first amount of time.

5. The method for processing application programming interface (API) requests at an API gateway of claim 2 wherein requests will be not be passed to a server when the number of failures is for the server is above a threshold setting related to the number of failures in a first amount of time.

6. The method for processing application programming interface (API) requests at an API gateway of claim 2 wherein requests will be not be passed to a server for a second amount of time when the number of failures is for the server is above a threshold setting related to the number of failures in a first amount of time.

7. The method for processing application programming interface (API) requests at an API gateway of claim 5 further comprising sending a fail fast response to a requester during the second amount of time.

8. The method for processing application programming interface (API) requests at an API gateway of claim 5 wherein the second amount of time includes a configurable-threshold period.

9. The method for processing application programming interface (API) requests at an API gateway of claim 7 further comprising sending a request to the server after the configurable threshold time.

10. The method for processing application programming interface (API) requests at an API gateway of claim 7 further comprising sending a request to the server after the second amount of time.

11. The method for processing application programming interface (API) requests at an API gateway of claim 9 further comprising opening the gateway for receiving requests upon receiving at least one completed request after the second amount of time has passed to allow sending of requests to the server.

12. An apparatus for processing application programming interface (API) requests at an API gateway, comprising:
a module for
receiving an API request at a first computing device, the request comprising a key identifying the source of the request and an identification of the target of the request;
authenticating the request by matching the key to a key in a key identification file, and
a sending module for sending the authenticated request to a server;
a circuit breaker for that server that receives authenticated requests when the circuit breaker is in a closed position;
a failure handler that
opens the circuit breaker in response to a threshold of failed requests for services for a first amount of time;
closes the circuit breaker after a second amount of time, the second amount of time to allow the server to recover to an operable state; and
after the second amount of time, allows at least one service request to pass to determine if the server is operable and which closes if a failed service request is generated by the server in response to passing the at least one service request.

13. The apparatus for processing application programming interface (API) requests at an API gateway of claim 11 wherein the failure handler generates a fail fast response to requests received during the second amount of time.

14. The apparatus for processing application programming interface (API) requests at an API gateway of claim 11 wherein the failure handler prevents requests from going to the server and generates a fail fast response to requests received during the second amount of time.

15. The apparatus for processing application programming interface (API) requests at an API gateway of claim 11 wherein the failure handler opens the circuit if the at least one service request fails at the server after the second amount of time.

16. An apparatus for processing application programming interface (API) requests at an API gateway, comprising:
a controller for
receiving an API request at a first computing device, the request comprising a key identifying the source of the request and an identification of the target of the request;
authenticating the request by matching the key to a key in a key identification file, and
a circuit breaker for a server that receives authenticated requests, the circuit breaker configured to operate as a part of a failure handling apparatus
the circuit breaker passing authenticated requests to the server in a closed position;
the circuit breaker opening to prevent authenticated requests from going to the server after a threshold of failed requests has been produced; and
the circuit breaker closed temporarily to allow a request to the server after a time sufficient for the server to be placed in an operable state.

17. The apparatus for processing application programming interface (API) requests at an API gateway of claim 15 wherein the failure handler apparatus generates a fail fast response to requests received during the time when the circuit breaker is open.

18. The apparatus for processing application programming interface (API) requests at an API gateway of claim 15 wherein the failure handler apparatus opens the circuit if the at least one service request fails at the server after the second amount of time.
